(19) United States
(12) Patent Application Publication
(10) Pub. No.: US 2014/0052420 A1
(43) Pub. Date: Feb. 20, 2014

(54) Digital Rock Analysis Systems and Methods that Estimate a Maturity Level

(71) Applicant: INGRAIN INC., Houston, TX (US)

(72) Inventor: Timothy CAVANAUGH, Houston, TX (US)

(73) Assignee: INGRAIN INC., Houston, TX (US)

(21) Appl. No.: 13/663,654

(22) Filed: Oct. 30, 2012

Related U.S. Application Data
(60) Provisional application No. 61/684,978, filed on Aug. 20, 2012.

(51) Int. Cl. G06F 17/10

(52) U.S. Cl. 703/2

(57) ABSTRACT

The pore structure of rocks and other materials can be determined through microscopy and subjected to digital simulation to determine the properties of the material such as its maturity level or conversion ratio. To determine the maturity level, some disclosed method embodiments obtain a 3D model of a rock sample; estimate volumes of organic matter; estimate volumes of pores with within the organic matter; calculate a conversion ratio as a function of the volumes of organic matter and the volumes of pores within the organic matter; correlate the conversion ratio with a maturity level, and display at least one of the conversion ratio and the maturity level.

### CROSS-REFERENCE TO RELATED APPLICATIONS

This application claims priority to Provisional U.S. Application Ser. No. 61/849,978 titled “Digital Rock Analysis Systems and Methods that Estimate a Maturity Level” and filed Aug. 20, 2012 by Timothy Cavanaugh, which is hereby incorporated herein by reference.

### BACKGROUND

Microscopy offers scientists and engineers a way to gain a better understanding of the materials with which they work. Under high magnification, it becomes evident that many materials (including rock and bone) have a porous microstructure that permits fluid flows. Such fluid flows are often of great interest, e.g., in subterranean hydrocarbon reservoirs. Accordingly, significant efforts have been expended to characterize materials in terms of their flow-related properties including porosity, permeability, and the relation between the two. Scientists typically characterize materials in the laboratory by applying selected fluids with a range of pressure differentials across the sample. Such tests often require weeks and are fraught with difficulties, including requirements for high temperatures, pressures, and fluid volumes, risks of leakage and equipment failure, and imprecise initial conditions. (Flow-related measurements are generally dependent not only on the applied fluids and pressures, but also on the history of the sample. The experiment should begin with the sample in a native state, but this state is difficult to achieve once the sample has been removed from its original environment.)

Accordingly, industry has turned to digital rock analysis to characterize the flow-related properties of materials in a fast, safe, and repeatable fashion. A digital representation of the material's pore structure is obtained and can be used to characterize the properties of the material. Efforts to increase the amount of information that can be derived from digital rock analysis are ongoing.

### BRIEF DESCRIPTION OF THE DRAWINGS

Accordingly, there are disclosed herein digital rock analysis systems and methods that estimate a maturity level of a rock sample. In the drawings:

FIG. 1 shows an illustrative high resolution focused ion beam and scanning electron microscope.

FIG. 2 shows an illustrative high performance computing network.

FIG. 3 shows an illustrative volumetric representation of a sample.

FIG. 4A shows an illustrative 2D scanning electron microscope (SEM) image of a rock sample.

FIG. 4B shows an enlarged segment of the 2D SEM image of FIG. 4A.

FIG. 5A shows an illustrative image of a distribution of pores for the segment of FIG. 4B.

FIG. 5B shows an illustrative image of a distribution of organic matter for the segment of FIG. 4B.

FIG. 5C shows an illustrative image of the overlap between the distribution of pores in FIG. 5A and the distribution of organic matter in FIG. 5B.

FIG. 6 is a flowchart of an illustrative digital rock analysis method.

FIG. 7 is a flowchart of another illustrative maturity level analysis method.

It should be understood, however, that the specific embodiments given in the drawings and detailed description below do not limit the disclosure. On the contrary, they provide the foundation for one of ordinary skill to discern the alternative forms, equivalents, and other modifications that are encompassed in the scope of the appended claims.

### DETAILED DESCRIPTION

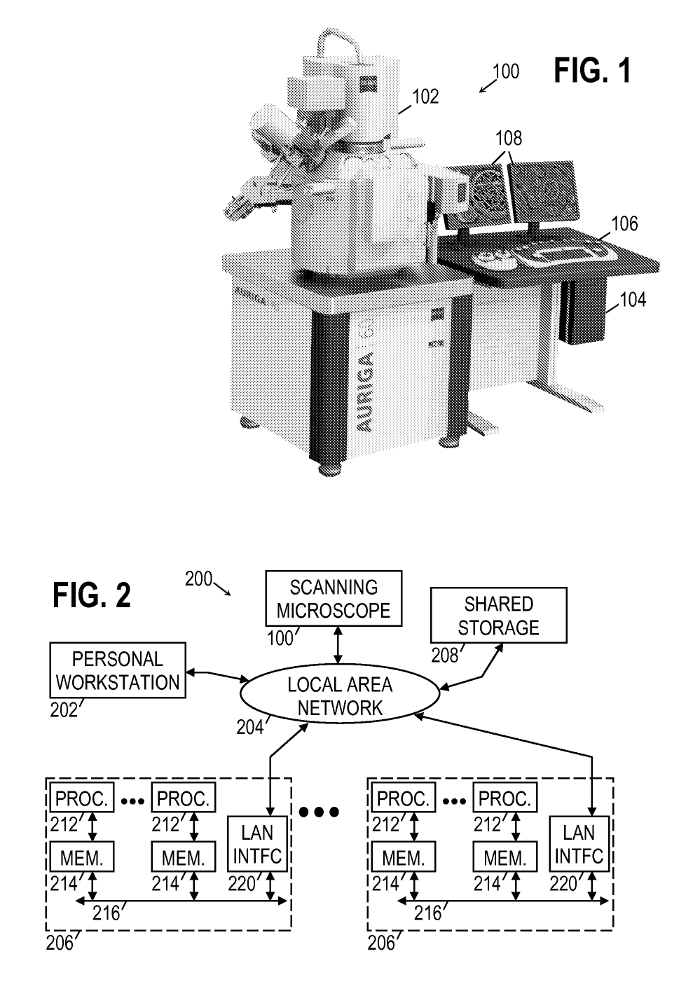

For context, FIG. 1 provides an illustration of a high-resolution focused ion beam and scanning electron microscope 100 having an observation chamber 102 in which a sample of material is placed. A computer 104 is coupled to the observation chamber instrumentation to control the measurement process. Software on the computer 104 interacts with a user via a user interface having one or more input devices 106 (such as a keyboard, mouse, joystick, light pen, touchpad, or touchscreen) and one or more output devices 108 (such as a display or printer).

For high resolution imaging, the observation chamber 102 is typically evacuated of air and other gases. A beam of electrons or ions can be rastered across the sample's surface to obtain a high resolution image. Moreover, the ion beam energy can be increased to mill away thin layers of the sample, thereby enabling sample images to be taken at multiple depths. When stacked, these images offer a three-dimensional image of the sample to be acquired. As an illustrative example of the possibilities, some systems enable such imaging of a 40×40×40 micrometer cube at a 10 nanometer resolution.

In an example process, the sample area identified for 3D imaging is mounted and inserted into a Zeiss Auriga™ FIB-SEM which uses a GEMIN™ electron column. The design of this column is what permits imaging at low energy with no surface coating. During the creation of the 3D dataset the FIB-SEM removes about 10 nm of material from a prepared area, SE2 and ESB images are taken, and then the FIB removes another 10 nm creating a new plane parallel to the one previously imaged. This process of milling and imaging is repeated around 600 to 1,000 times and vertical orientation of all images is preserved. After all individual FIB-SEM images are captured, they are aligned and merged into separate SE2 and BSE 3D objects with each image voxel having dimensions of from 10 to 15 nanometers. An example FIB-SEM volume used for analysis represents about 1×1⁰⁻¹⁰ g of rock.

The system of FIG. 1 is only one example of the technologies available for imaging a sample. Transmission electron microscopes (TEM) and three-dimensional tomographic x-ray transmission microscopes are two other technologies that can be employed to obtain a digital model of the sample. Regardless of how the images are acquired, the following disclosure applies so long as the resolution is sufficient to reveal the porosity structure of the sample.

The source of the sample, such as in the instance of a rock formation sample, is not particularly limited. For rock formation samples, for example, the sample can be sidewall cores, whole cores, drill cuttings, outcrop quarrying samples, or other sample sources which can provide suitable samples for analysis using methods according to the present disclosure.

FIG. 2 is an example of a larger system 200 within which the scanning microscope 100 can be employed. In the larger system 200, a personal workstation 202 is coupled to the scanning microscope 100 by a local area network (LAN) 204. The LAN 204 further enables intercommunication between the scanning microscope 100, personal workstation 202, one or more high performance computing platforms 206, and one or more shared storage devices 208 (such as a RAID, NAS, SAN, or the like). The high performance computing platform 206 generally employs multiple processors 212 each coupled to a local memory 214. An internal bus 216 provides high bandwidth communication between the multiple processors (via the local memories) and a network interface 220. Parallel processing software resident in the memories 214 enables the multiple processors to cooperatively break down and execute the tasks to be performed in an expedited fashion, accessing the shared storage device 208 as needed to deliver results and/or to obtain the input data and intermediate results.

Typically, a user would employ a personal workstation 202 (such as a desktop or laptop computer) to interact with the larger system 200. Software in the memory of the personal workstation 202 causes its one or more processors to interact with the user via a user interface, enabling the user to, e.g., craft and execute software for processing the images acquired by the scanning microscope. For tasks having small computational demands, the software may be executed on the personal workstation 202, whereas computationally demanding tasks may be preferentially run on the high performance computing platform 206.

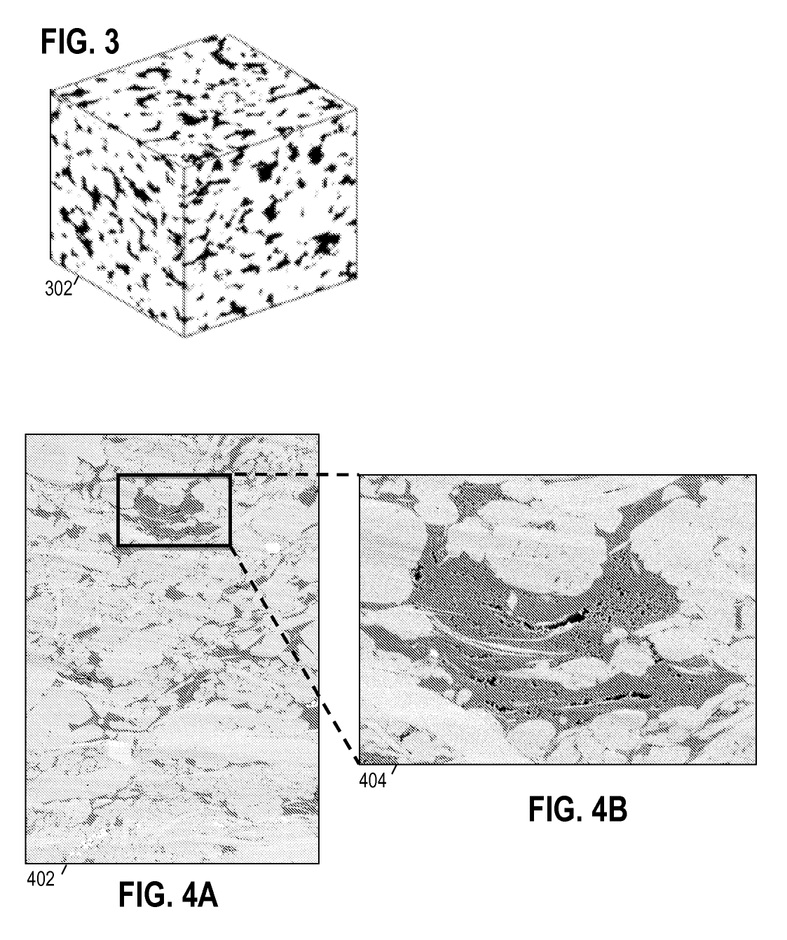

FIG. 3 is an illustrative image 302 that might be acquired by the scanning microscope 100. This three-dimensional image is made up of three-dimensional volume elements (“voxels”) each having a value indicative of the composition of the sample at that point.

One way to characterize the porosity structure of a sample is to determine an overall parameter value, e.g., porosity. For example, the image 302 may be processed to categorize each voxel as representing a pore or a portion of the matrix, thereby obtaining a pore/matrix model in which each voxel is represented by a single bit indicating whether the model at that point is matrix material or pore space. Further, non-pore voxels may be categorized as organic matter or non-organic matter. The process of classifying voxels as pores, organic matter, or non-organic matter is sometimes called segmentation. Through the voxel classification process, porosity volumes, organic matter volumes, and non-organic matter volumes for a sample can be estimated with a straightforward counting procedure. Further, 3D volumes may be segmented using 3D algorithms that separate pore space, porosity associated with organic material (PAOM), solid OM, and solid matrix framework into separate 3D volumes. Without limitation to other examples, the local porosity theory set forth by Hilfer, (“Transport and relaxation phenomena in porous media” Advances in Chemical Physics, XCII, pp 299-424, 1996, and Biswal, Manwarth and Hilfer “Three-dimensional local porosity analysis of porous media” Physica A, 255, pp 221-241, 1998), when given a subvolume size, may be used to determine the porosity of each possible subvolume in the sample or its 3D model.

FIG. 4A shows an illustrative 2D scanning electron microscope (SEM) image 402 of a rock sample. Meanwhile, FIG. 4B shows an enlarged segment 404 of the 2D SEM image 402. The image 402 or the enlarged segment 404 may correspond to, for example, a slice in a volume or subvolume of a rock sample or its corresponding 3D model.

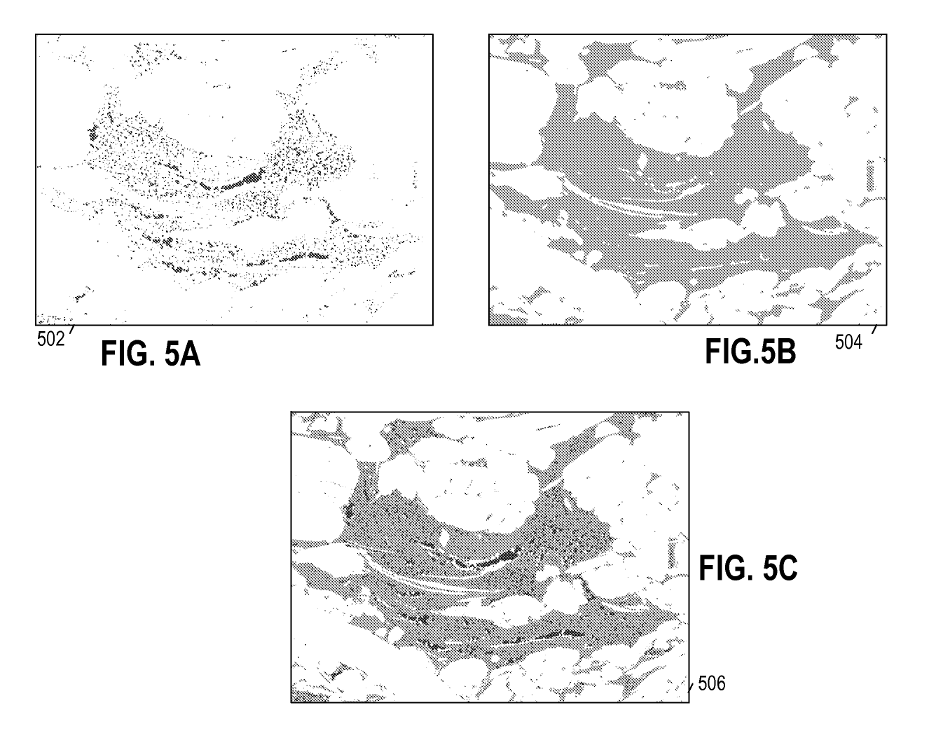

In FIG. 5A, an illustrative image 502 of a distribution of pores (shown in black) for the segment 404 is shown. Meanwhile, FIG. 5B shows an illustrative image 504 of a distribution of organic matter (shown in gray) for the segment 404. Finally, FIG. 5C shows an illustrative image 506 of the overlap between the distribution of pores in FIG. 5A and the distribution of organic matter in FIG. 5B. The images 502, 504, 506 of FIGS. 5A-5C are illustrative only and are not intended to limit analysis of a rock sample maturity level or conversion ratio to any particular technique.

In accordance with examples of the disclosure, the amount of porosity within organic matter bodies is estimated for a rock sample (e.g., from a shale of interest). Further, the amount of porosity may be correlated to a thermal maturity level for the rock sample based on the assumption that porosity associated with organic matter, PAOM, is created by the conversion of solid organic matter to hydrocarbons (gas or oil or both).

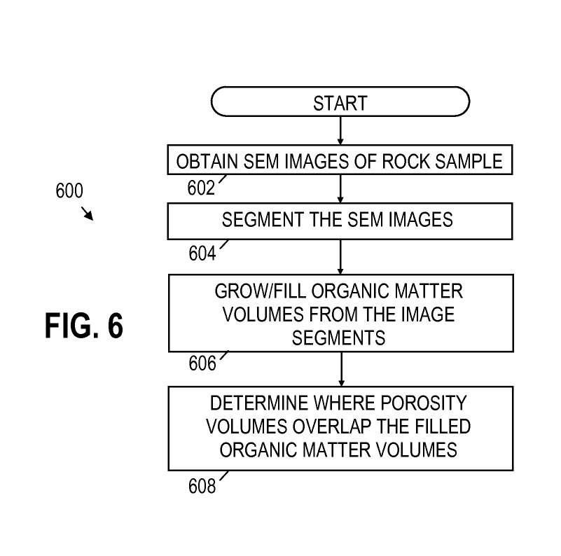

As an example, the amount of porosity within organic matter (OM) may be estimated by using high resolution SEM images of ion-polished shale samples. FIG. 6 is a flowchart 600 of an illustrative digital rock analysis method. The flowchart 600 may be performed, for example, by a computer executing digital rock analysis software. As shown, the illustrative workflow begins in block 602, where SEM images of a rock sample are obtained. The SEM images are segmented at block 604, in other words, pores, organic matter, or non-organic matter may be identified from the SEM images based on voxel analysis or other techniques. At block 606, organic matter volumes are grown/filled from the image segments. Further, at block 608, a determination is made regarding where porosity volumes overlap the grown/filled organic matter volumes. The result of the overlap process of block 608 is the porosity that is present within the constraints of organic matter bodies (PAOM).

In accordance with examples of the disclosure, PAOM results may be normalized to the bounds of the organic matter bodies using the following calculation: Conversion Ratio (CR)=PAOM/(PAOM+OM). For example, if PAOM corresponds to 2.7% of an image and solid OM corresponds to 7.4% of the image, then the CR for the image is 2.7/(2.7+7.4)=0.27 or 27%. The CR for a plurality of images or slices corresponding to a rock sample may similarly be calculated and used to estimate the CR for the rock sample. Further, the CR may be correlated to a maturity level of the rock sample. For example, a CR of 27% may be interpreted to mean that 27% of available OM for a rock sample (or region from which the rock sample was taken) has been converted to hydrocarbons.

As previously noted, it should be understood that various digital rock analysis techniques for determining porosity within organic matter are possible, and that the CR or maturity level calculation may he determined based on these different techniques. For example, U.S. Provisional Application 61/618,265 titled “An efficient method for selecting representative elementary volume in digital representations of porous media” and filed Mar. 30, 2012 by inventors Giuseppe De Prisco and Jonas Toelke (and continuing applications thereof) be used to determine porosity within organic matter of a sample, and may determine whether reduced-size portions of the original data volume adequately represent the whole for porosity- and permeability-related analyses. Further, various methods for determining permeability from a pore/matrix model are set forth in the literature including that of Papatzacos “Cellular Automation Model for Fluid Flow in Porous Media”, Complex Systems 3 (1989) 383-405. Any of these permeability measurement methods can be employed in the current process to determine a permeability value (or a correlated porosity value) for a given subvolume.

The disclosed CR calculation and maturity level calculation may be based on digital rock models of various sizes. The size of the model may be constrained by various factors including physical sample size, the microscope's field of view, or simply by what has been made available by another party.

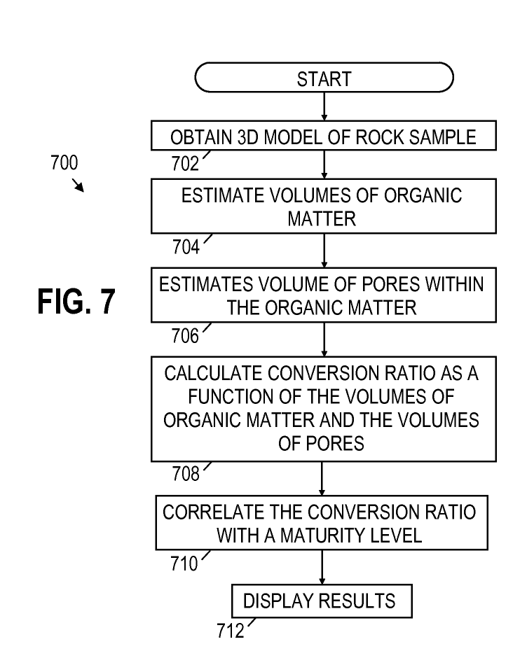

FIG. 7 is a flowchart of an illustrative maturity level analysis method. The illustrative workflow begins in block 702, where a three-dimensional model of a rock sample is obtained. Volumes of organic matter are estimated for the three-dimensional model at block 704. Further, volumes of pores within the organic matter are estimated at block 706. Without limitation to other examples, the organic matter volumes of block 704 and the pore volumes of block 706 are estimated based on analysis of voxels or image segments as described herein. The conversion ratio is then calculated as a function of the volume of organic matter and the volume of pores within the organic matter at block 708. For example, the conversion ratio may be CR=PAOM/(PAOM+OM). The conversion ratio may be calculated for a plurality of sub-volumes or images associated with a rock sample. In such case, an average conversion rat o or other conversion ratio calculations may be determined for the plurality of sub-volumes or images. At block 710, the conversion ratio is correlated with a maturity level, and the results are displayed at block 712. For example, the conversion ratio, the maturity level, or related images may be displayed on a computer performing the maturity level analysis method of flowchart 700.

For explanatory purposes, the operations of the foregoing method have been described as occurring in an ordered, sequential manner, but it should be understood that at least some of the operations can occur in a different order, in parallel, and/or in an asynchronous manner.

Numerous variations and modifications will become apparent to those skilled in the art once the above disclosure is fully appreciated. It is intended that the following claims be interpreted to embrace all such variations and modifications.

What is claimed is:

1. A method that comprises:
calculating a conversion ratio of organic matter to hydrocarbons in a rock sample; and
correlating the conversion ratio with a maturity level of an organic matter body associated with the rock sample; and
displaying at least one of the conversion ratio and the maturity level.

2. The method of claim 1, wherein calculating the conversion ratio comprises:
obtaining a three-dimensional model of the rock sample;
estimating a volume of organic matter within the three-dimensional model;
estimating a volume of pores within the organic matter; and
calculating the conversion ratio as a function of the volume of pores compared to the volume of the organic matter and the volume of pores.

3. The method of claim 2, wherein calculating the conversion ratio further comprises analyzing the three-dimensional model as a plurality of sub-volumes, and wherein estimating the volume of organic matter is based on estimating a volume of organic matter for each of the plurality of sub-volumes.

4. The method of claim 2, wherein calculating the conversion ratio further comprises analyzing the three-dimensional model as a plurality of sub-volumes, and wherein estimating the volume of pores is based on estimating a volume of pores within organic matter for each of the plurality of sub-volumes.

5. The method of claim 2, wherein calculating the conversion ratio further comprises analyzing the three-dimensional model as a plurality of images, and wherein estimating the volume of organic matter is based on estimating a percentage of an image corresponding to organic matter for each of the plurality of images.

6. The conversion ratio method of claim 2, wherein calculating the conversion ratio further comprises analyzing the three-dimensional model as a plurality of images, and wherein estimating the volume of pores is based on estimating a percentage of an image corresponding to pores within organic matter for each of the plurality of images.

7. The conversion ratio method of claim 2, wherein estimating the volume of pores within the organic matter comprises determining a position of organic matter volumes including any porosity within the three-dimensional model, determining a position of porosity volumes within the three-dimensional model, and determining where the position of porosity volumes overlaps with the position of organic matter volumes.

8. A system comprises:
a memory having software; and
one or more processors coupled to the memory to execute the software, the software causing the one or more processors to:
calculate a conversion ratio of organic matter to hydrocarbons in a rock sample; and
correlate the conversion ratio with a maturity level of an organic matter body associated with the rock sample; and
display at least one of the conversion ratio and the maturity level.

9. The system of claim 8, wherein the software further causes the one or more processors to:
obtain a three-dimensional model of the rock sample;
estimate a volume of organic matter within the three-dimensional model;
estimate a volume of pores within the organic matter; and
calculate the conversion ratio as a function of the volume of pores compared to the volume of the organic matter and the volume of pores.

10. The system of claim 9, wherein the software further causes the one or more processors to analyze the three-dimensional model as a plurality of sub-volumes, and to estimate the volume of organic matter by estimating a volume of organic matter for each of the plurality of sub-volumes.

11. The system of claim 9, wherein the software further causes the one or more processors to analyze the three-dimensional model as a plurality of sub-volumes, and to estimate the volume of pores by estimating a volume of pores within organic matter for each of the plurality of sub-volumes.

12. The system of claim 9, wherein the software further causes the one or more processors to analyze the three-dimensional model as a plurality of images, and to estimate the volume of organic matter by estimating a percentage of an image corresponding to organic matter for each of the plurality of images.

13. The system of claim 9, wherein the software further causes the one or more processors to analyze the three-dimensional model as a plurality of images, and to estimate the volume of pores by estimating a percentage of an image corresponding to pores within organic matter for each of the plurality of images.

14. The conversion ratio determination system of claim 9, wherein the software further causes the one or more processors to obtain the three-dimensional model based on a plurality of scanning electro microscope (SEM) images of an ion-polished rock sample, and to segment the plurality of SEM images to estimate the volume of organic matter and the volume of pores within the organic matter.

15. A non-transitory computer-readable medium storing software that, when executed, causes one or more processors to:
calculate a conversion ratio of organic matter to hydrocarbons in a rock sample; and
correlate the conversion ratio with a maturity level of an organic matter body associated with the rock sample; and
display at least one of the conversion ratio and the maturity level.

16. The non-transitory computer-readable medium of claim 15, wherein the software, when executed, further causes the one or more processors to:
obtain a three-dimensional model of the rock sample;
estimate a volume of organic matter within the three-dimensional model;
estimate a volume of pores within the organic matter; and
calculate the conversion ratio as a function of the volume of pores compared to the volume of the organic matter and the volume of pores.

17. The non-transitory computer-readable medium of claim 16, wherein the software, when executed, further causes the one or more processors to analyze the three-dimensional model as a plurality of sub-volumes, and to estimate the volume of organic matter and the volume of pores within organic matter for each of the plurality of sub-volumes.

18. The non-transitory computer-readable medium of claim 16, wherein the software, when executed, further causes the one or more processors to analyze the three-dimensional model as a plurality of images, and to estimate the volume of organic matter by estimating a percentage of an image corresponding to organic matter for each of the plurality of images.

19. The non-transitory computer-readable medium of claim 16, wherein the software, when executed, further causes the one or more processors to analyze the three-dimensional model as a plurality of images, and to estimate the volume of pores by estimating a percentage of an image corresponding to pores within organic matter for each of the plurality of images.

20. The non-transitory computer-readable medium of claim 16, wherein the software, when executed, causes the one or more processors to estimate the volume of pores within the organic matter by determining a position of organic matter volumes including any porosity within the three-dimensional model, determining a position of porosity volumes within the three-dimensional model, and determining where the position of porosity volumes overlaps with the position of organic matter volumes.
